(19) United States
(12) Patent Application Publication
(10) Pub. No.: US 2008/0191423 A1
(43) Pub. Date: Aug. 14, 2008

(54) Sealant template for use in sealing joints and method of sealing joints

(76) Inventor: Binyamin Cohen, Saddle Brook, NJ (US)

Correspondence Address: BRUCE L. ADAMS, ESQ.;SUITE 1231, 17 BATTERY PLACE, NEW YORK, NY, 10004, US

(21) Appl. No.: 11/705,670

(22) Filed: Feb. 13, 2007

(51) Int. Cl. B60J 10/00

(52) U.S. Cl. 277/316

(57) ABSTRACT

A sealant template for use in sealing a joint between a component and a vessel to which the component is attached comprises a support member on which are adhesively adhered inner and outer template sections. The inner template section has a ring-shape having an outer profile similar to but smaller than the periphery of the base of the component, and the outer template section has a ring-shape having an inner profile similar to but larger than the periphery of the base of the component. When the inner template section is adhesively adhered to the base of the component and the outer template section is adhesively adhered to the vessel surface, a ring-shaped gap exists between the inner and outer template sections at the joint between the component and the vessel to facilitate application of sealant to the joint. The inner and outer template sections may be provided with tabs to facilitate removal of the template sections from the backing member and adherence thereof to the component and the vessel. The inner and outer template sections may be provided with weakened regions to enable separation of the template sections into plural template section pieces to simplify adhering the template sections to the component and the vessel. The weakened regions may be formed by perforated lines or score lines.

### FIELD OF THE INVENTION

The present invention relates to a sealant template for applying sealant to a joint between two surfaces and, more particularly, relates to a sealant template having inner and outer template sections that can be adhesively adhered, one to each surface, to form a ring-shaped gap at the joint between the two surfaces for use in applying sealant to the joint.

### BACKGROUND OF THE INVENTION

Many vessels, such as aircraft, marine craft and vehicles, have one or more antennae installed on external surfaces thereof, or have other components such as connectors, windows and lights that are installed on or mate with external surfaces thereof. For example, aircraft have many external antennae, ranging between 3 and 15 on average, for use in navigation and communication. When such components are attached to the external surface of the vessel, it is necessary to seal the joint created between the base of the component and the surface of the vessel to prevent penetration of water, air, dirt, and other air-borne contaminants into the joint.

In the case of aircraft, it is common practice to seal the joint between an antenna and the surface of the aircraft using masking tape to form a template for the sealant. After installation of the antenna on the aircraft, strips of masking tape are applied in an overlapping manner around the base of the antenna, and strips of masking tape are similarly placed on the surface of the aircraft in an overlapping manner around the periphery of the antenna base so as to leave an exposed ring-shaped space at the joint between the antenna and the aircraft. A sealant is then applied in the space of the joint after which the masking tape strips are removed, leaving only the sealant in the joint.

Since antenna bases have numerous shapes, sizes, and contours, many strips of masking tape must be applied, both to the antenna base and to the aircraft surface, in an overlapping manner to trace the periphery of the antenna base. This is a very time-consuming and meticulous task and produces a ring-shaped gap that is jagged, irregular and non-uniform. As a consequence, when the strips of masking tape are removed, the sealant bead in the joint likewise has a jagged, irregular and non-uniform shape. Moreover, to ensure that the joint is properly sealed, the gap is often made unnecessarily large and it is not possible, using strips of masking tape, to create a uniform gap around the joint. Further, the sealant bead is jagged and irregular and presents an unattractive, almost sloppy appearance. Similar problems and drawbacks exists when sealing the joints between other components and vessels.

### SUMMARY OF THE INVENTION

Accordingly, it is a principal object of the present invention to provide a sealant template that overcomes the foregoing drawbacks.

Another object of the present invention is to provide a sealant template that can be quickly and easily used to facilitate the application of sealant to a joint between a component and a vessel to which the component is attached.

A further object of the present invention is to provide a sealant template having inner and outer template sections that can be peeled off a backing sheet and adhesively adhered, one to the base of the component and the other to the vessel surface, to form a uniform ring-shaped gap around the joint between the component and the vessel for use in applying sealant.

A still further object of the present invention is to provide a sealant template having inner and outer template sections that can be separated into plural template section pieces to facilitate adhering the template sections to the component and the vessel.

Yet another object of the present invention is to provide a sealant template in which the inner and outer template sections are provided with tabs to facilitate removal of the template sections from a backing member on which the template sections are adhesively adhered.

A still further object of the present invention is to provide a method of sealing a joint between a component and a vessel to which the component is attached using a sealant template having inner and outer template sections.

Another object of the present invention is to provide a sealant template that can be economically manufactured in large quantities using commercially available equipment.

Another object of the present invention is to provide sealant templates designed for use with components having different sizes, shapes and contours.

These as well as other objects of the present invention are achieved by a sealant template having a support member on which are adhesively adhered inner and outer template sections. The inner template section has a ring-shape having an outer profile similar to but smaller than the periphery of the base of the component, and the outer template section has a ring-shape having an inner profile similar to but larger than the periphery of the base of the component. When the inner template section is adhesively adhered to the base of the component and the outer template section is adhesively adhered to the vessel surface, a ring-shaped gap exists between the inner and outer template sections at the joint between the component and the vessel to facilitate application of sealant to the joint.

The inner and outer template sections may be provided with tabs to facilitate removal of the template sections from the backing member and adherence thereof to the component and the vessel. The inner and outer template sections may be provided with weakened regions to enable separation of the template sections into plural template section pieces to simplify adhering the template sections to the component and the vessel. The weakened regions may be formed by perforated lines or score lines.

The above and further objects, features and advantages of the present invention will become clear from a reading of the following detailed description of the invention in conjunction with the accompanying drawings.

### BRIEF DESCRIPTION OF THE DRAWINGS

FIG. 1 is a perspective view of a transponder antenna as an example of a component with which the sealant template of the present invention can be used;

FIG. 2 is a top plan view of one example of a sealant template according to the present invention for use with the transponder antenna of FIG. 1;

FIG. 3 is a perspective view of the responder antenna of FIG. 1 attached to an aircraft fuselage with the inner and outer template sections adhered thereto during application of a sealant;

FIG. 4 is a perspective view showing the transponder antenna of FIG. 3 sealed to the aircraft fuselage with the inner and outer template sections removed;

FIG. 5 is a perspective view of another example of an antenna with which the sealant template of the present invention can be used;

FIG. 6 is a top plan view of another example of a sealant template according to the present invention for use with the antenna shown in FIG. 5;

FIG. 7 is another example of an antenna with which the sealant template of the present invention can be used; and

FIG. 8 is a top plan view of another example of a sealant template according to the present invention for use with the antenna shown in FIG. 7.

### DETAILED DESCRIPTION OF THE INVENTION

For illustrative purposes, several examples of sealant templates according to the present invention will be described with reference to antennae of different shapes for installation on aircraft. The invention is not, of course, limited to use with antennae of these shapes but rather may be used with antennae of any size and shape as well as with many other kinds of components other than antennae, such as connectors, windows, lights and the like. The invention is also not restricted for use with aircraft and, as will be readily recognized by those skilled in the art, the sealant template of the invention may be used for sealing components to vessels of any type, such as vehicles, boats, ships and other marine craft where weather-proofing is required. For illustrative purposes only, throughout the following description, reference will be made to the vessel being an aircraft and the component being an antenna as shown in the illustrative examples in the drawings.

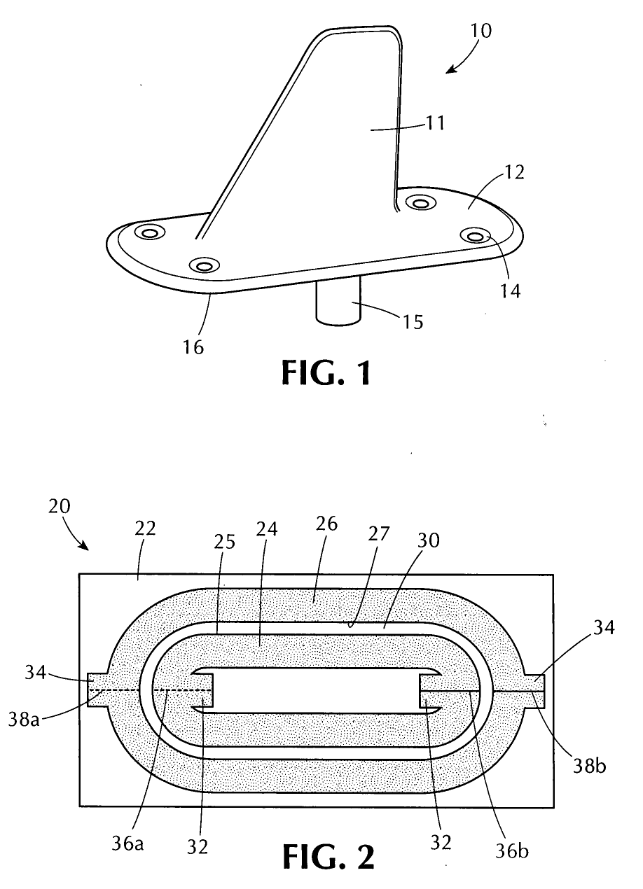

FIG. 1 shows a transponder antenna 10 having a blade 11 connected to a mounting base 12, which are typically die-cast as a one-piece structure. The mounting base 12 has a set of mounting holes 14 for attachment of the antenna 10 to the fuselage of an aircraft. A connector 15 projects downwardly from the underside of the mounting base 12 and, when the antenna is installed on the aircraft, the connector extends into an opening in the fuselage and is connected to an electrical cable (not shown). The mounting base 12 of the antenna 10 has an oblong shape with an outer peripheral edge 16 that defines the oblong peripheral profile of the antenna.

FIG. 2 shows a sealant template 20 designed for use with the antenna 10. The sealant template 20 comprises a support member 22, and inner and outer template sections 24 and 26 that are removably adhesively adhered to the support member 22. The support member 22 is preferably in the form of a release paper or backing paper to which the template sections 24 and 26 are adhesively adhered to enable them to be peeled off the support member 22 as described below. The inner and outer template sections 24 and 26 are in the form of adhesive-backed stickers and may be formed of any suitable material that is compatible with the sealant being used.

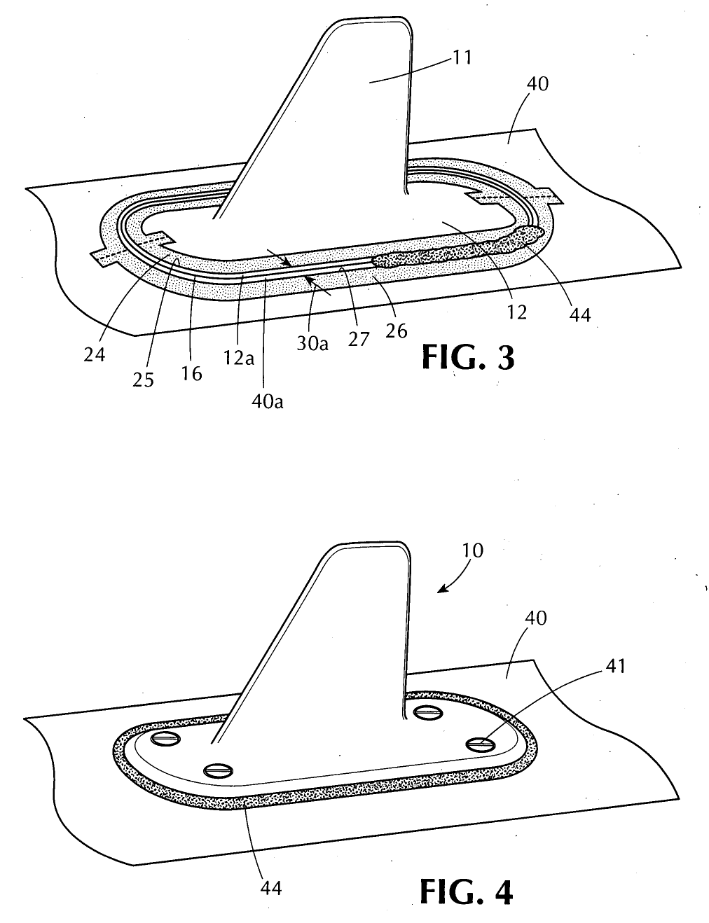

As shown in FIGS. 2-3, the inner and outer template sections 24 and 26 have a ring shape. As used herein, the term “ring-shape” is used in its broad sense and means a substantially closed-loop shape having any configuration, such as oblong, elliptical, circular, rectangular, triangular, polygonal and the like. The configuration of the ring-shape is determined by the shape of the outer periphery of the mounting base of the component with which the sealant template is to be used.

In the example shown in FIGS. 1-4, the inner and outer template sections 24 and 26 have oblong ring-shapes which are similar to the oblong peripheral profile 16 of the mounting base 12. More particularly, the inner template section 24 has an outer profile 25 that is geometrically similar to but smaller than the peripheral profile 16 of the antenna 10, and the outer template section 26 has an inner profile 27 that is geometrically similar to but larger than the peripheral profile 16 of the antenna. By such a relationship, when the inner template section 24 is disposed inside the outer template section 26 as shown in FIG. 2, a ring-shaped gap 30 exists between the outer profile 25 of the inner template section 24 and the inner profile 27 of the outer template section 26. This gap, as explained below, registers with the joint or boundary region between the antenna 10 and the aircraft fuselage and forms a template for applying the sealant.

The method of using the sealant template 20 will be described with reference to FIGS. 3-4. First, the antenna 10 is installed on a fuselage 40 of the aircraft, such as by screws 41 inserted through the mounting holes 14. A suitable conductive gasket (not shown) may be interposed between the antenna 10 and the fuselage 40 in a manner well known in the art. The inner template section 24 is then peeled off the support member 22 and removably adhesively adhered to the mounting base 12 of the antenna 10, as shown in FIG. 3, such that the outer profile 25 of the inner template section registers with the peripheral profile 16 of the antenna. Since the outer profile 25 of the inner template section 24 is similar to but smaller than the peripheral profile 16 of the antenna, a small ring-shaped peripheral portion 12a of the mounting base 12 remains exposed, i.e., not covered by the inner template section 24.

In a similar manner, the outer template section 26 is peeled off the support member 22 and removably adhesively adhered to the fuselage 40 outside the inner template section 24. Since the inner profile 27 of the outer template section 26 is similar to but larger than the peripheral profile 16 of the antenna 10, a small ring-shaped portion 40a of the fuselage remains exposed, i.e., not covered by the outer template section 26. In this manner, after the inner and outer template sections 24 and 26 are adhered to the antenna 10 and the fuselage 40, respectively, a ring-shaped gap 30a exists between the inner and outer template sections at the joint or boundary region between the outer periphery of the antenna 10 and the fuselage 40. The ring-shaped gap 30a registers with the joint or boundary region between the antenna 10 and the fuselage 40 and corresponds to the sum of the ring-shaped peripheral portion 12a of the mounting base 12 and the ring-shaped portion 40a of the fuselage 40 and forms a template for applying the sealant.

It is understood, of course, that the outer template section 26 may be adhered to the fuselage 40 before adhering the inner template section 24 to the mounting base 12 of the antenna 10. The order in which the inner and outer template sections 24 and 26 are adhered to the antenna 10 and the fuselage 40 is purely a matter of choice.

A technician then fills the ring-shaped gap 30a with a suitable resin 44, completely filling the gap and covering the opposed edges of the inner and outer template sections 24 and 26, as shown in FIG. 3. The resin 44 is smoothed into a bead that completely fills the ring-shaped gap 30a and overlaps the opposed edges of the inner and outer template sections. Then the inner template section 24 is peeled off the antenna 10 and the outer template section 26 is peeled off the fuselage 40, leaving a uniform bead of sealant 44 that completely surrounds and seals the joint between the antenna 10 and the fuselage 40, as shown in FIG. 4. In this manner, the joint or boundary region between the antenna and the fuselage can be quickly and effectively sealed, and the sealant bead presents a neat, attractive appearance.

The sealant 44 is preferably a self-curing resin that cures at ambient temperature. Such resins are well known in the art and may be applied with an extrusion gun, spatula or other means. Such resins provide pressure and fluidtight sealing and are commonly used for aircraft and marine craft applications.

To facilitate removal of the inner and outer template sections 24 and 26 from the support member 22, the template sections are provided with tabs. As shown in FIG. 2, the inner template section 24 is provided with at least one, and preferably two, tabs 32, 32 which extend radially inwardly from the inner template section 24. The outer template section 26 is also provided with one, and preferably two, tabs 34, 34 which extend radially outwardly from the outer template section 26. Though the tabs 32 and 34 are shown located at diametrically opposite positions on the inner and outer template sections, they may be located at any desired positions on the template sections. The tabs 32 and 34 are sufficiently large so that a technician can easily grasp the tabs and peel the template sections from the support member 22. The tabs 32 and 34 also facilitate positioning and placement of the inner and outer template sections 24 and 26 on the antenna 10 and the fuselage 40, respectively.

If desired, and usually in the case of large-sized components, the template sections may be provided with weakened regions to enable separation of the template sections into two or more template section pieces. For example, as shown in FIG. 2, the inner template section 24 has weakened regions 36a and 36b, and the outer template section 26 has weakened regions 38a and 38b. The weakened regions 36a and 38a comprise perforated lines, and the weakened regions 36b and 38b comprise score lines. Though both perforated lines and score lines are shown in FIG. 2, in actual practice the weakened regions of each sealant template 20 will be of the same kind, i.e., either perforated lines, score lines or some other form. The weakened regions are preferably provided at the tabs 32 and 34, which facilitates gripping of the tabs by the technician and separation of the inner and outer template sections 24 and 26 along the weakened regions into separate template section pieces either during removal of the template sections from the support member 22 or after removal thereof from the support member.

The sealant template 20 may be made by adhering either a roll or sheets of adhesive-backed template paper (such as masking tape, painter's tape or other suitable adhesive tape) to a roll or sheets of backing paper and then die cutting or stamping the sealant templates, after which the unwanted portions of the template paper are removed, leaving the inner and outer template sections 24 and 26 adhered to the backing paper 22 as shown in FIG. 2. Usually a plurality of sealant templates 20 would be die cut or stamped at one time, and the resulting sealant templates may be sold in quantity in either roll or sheet form, or separated and sold as individual sealant templates. The configuration or shape of the sealant templates is designed to match the outer periphery or profile of the base of the components with which the sealant templates are to be used.

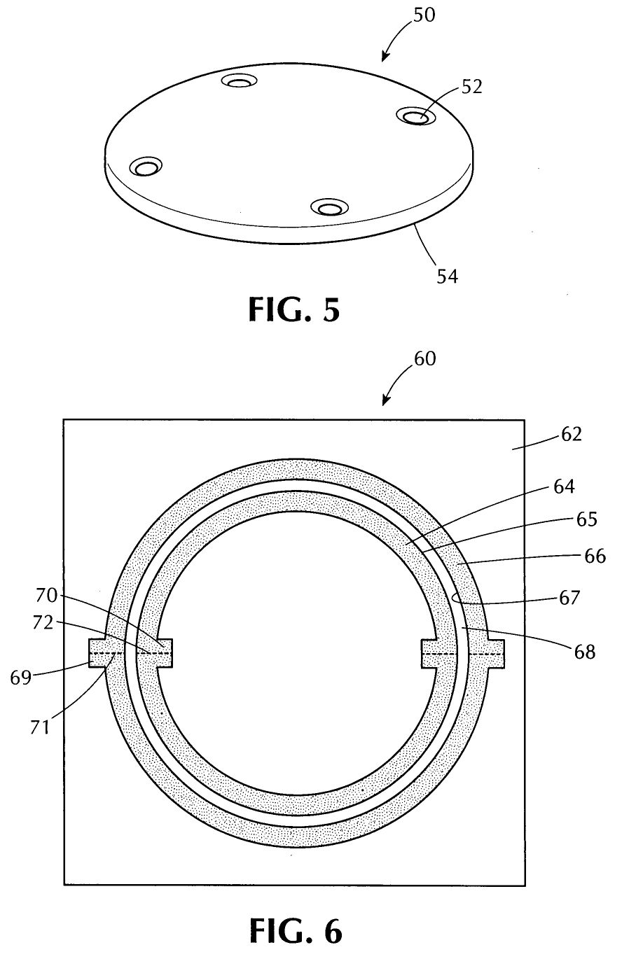

FIG. 5 illustrates an antenna 50 having mounting holes 52 for attachment of the antenna to the fuselage of an aircraft. The antenna 50 has a mounting base of circular shape with an outer peripheral edge 54 that defines the circular peripheral profile or outline of the antenna.

FIG. 6 shows a sealant template 60 designed for use with the antenna 50. The sealant template 60 comprises a support member 62, and inner and outer template sections 64 and 66 that are removably adhered by adhesive to the support member 62. The inner template section 64 has an outer profile 65 that is geometrically similar to but smaller than the peripheral profile 54 of the antenna 50, and the outer template section 66 has an inner profile 67 that is geometrically similar to but larger than the peripheral profile 54 of the antenna. As shown in FIG. 6, when the inner template section 64 is disposed inside the outer template section 66, a ring-shaped gap 68 exists between the outer profile 65 of the inner template section 64 and the inner profile 67 of the outer template section 66. When the template sections 64 and 66 are applied to the antenna 50 and the aircraft fuselage (not shown), the ring-shaped gap 68 registers with the joint or boundary region between the antenna 50 and the aircraft fuselage and forms a template for applying the sealant.

The outer template section 66 is provided with one or more tabs 69, and the inner template section 64 is provided with one or more tabs 70. The tabs 69 extend radially outwardly from the outer template section 66, and the tabs 70 extend radially inwardly from the inner template section 64. The outer template section 66 is provided with one or more weakened regions 71, and the inner template section 64 is provided with one or more weakened sections 72.

The method of manufacturing the sealant template 60 and its manner of use are similar to those described above with reference to the sealant template 20.

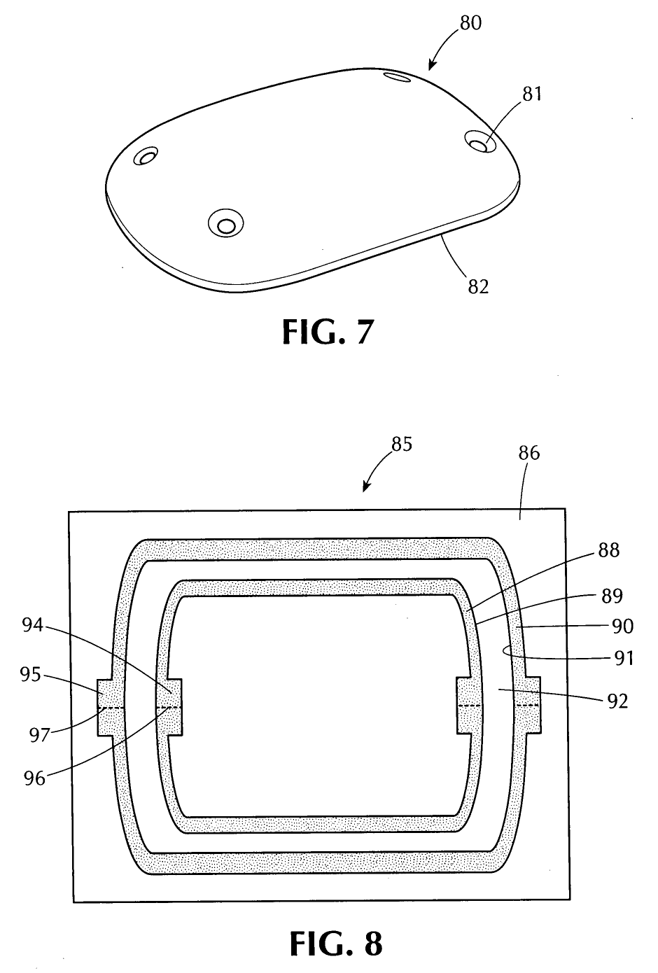

FIG. 7 shows another example of an antenna 80 of generally rectangular shape. The antenna 80 has a set of mounting holes 81 for attaching the antenna to an aircraft fuselage (not shown). The mounting base of the antenna 80 has a rectangular shape with an outer peripheral edge 82 that defines the rectangular peripheral profile or outline of the antenna.

FIG. 8 shows a sealant template 85 designed for use with the antenna 80. The sealant template 85 comprises a support member 86, and inner and outer template sections 88 and 90 that are removably adhered by adhesive to the support member 86. The inner template section 88 has an outer profile 89 that is geometrically similar to but smaller than the peripheral profile 82 of the antenna 80, and the outer template section 90 has an inner profile 91 that is geometrically similar to but larger than the peripheral profile 82 of the antenna. When the inner template section 88 is positioned inside the outer template section 90 as shown in FIG. 8, a ring-shaped gap 92 exists between the outer profile 89 of the inner template section 88 and the inner profile 91 of the outer template section 90. When the inner and outer template sections 88 and 90 are adhered to the antenna 80 and the aircraft fuselage, respectively, the gap 92 registers with the joint or boundary region between the antenna 80 and the aircraft fuselage and forms a template for applying the sealant.

Due to the contour of the antenna 80, the ring-shaped gap 92 does not have a uniform dimension but rather is wider at its two shorter sides than at its two longer sides. In accordance with the invention, the shape of the ring-shaped gap is dependent on the shape and contour of the antenna or other component with which the sealant template is to be used.

The inner template section 88 is provided with one or more tabs 94 that extend radially inwardly, and the outer template section 90 is provided with one or more tabs 95 that extend radially outwardly. In this example, two tabs are provided on each of the inner an outer template sections. The tabs 94 are provided with weakened sections 96, and the tabs 95 are provided with weakened sections 97 to enable separation of the inner and outer template sections into plural template section pieces.

The method of making the sealant template 85 and its manner of use are the same as those described above with reference to the sealant template 20.

Though the invention has been described with reference to sealant templates designed for use with antennae of different shapes that are attached to aircraft, the invention is not so limited but rather is applicable to sealant templates designed for use with numerous kinds of components installed on various kinds of vessels. The component may be a connector, window, light, panel or any other component that requires weather-proofing and/or pressure sealing. The vessel may be any kind of vehicle, such as cars or trucks, aircraft or marine craft, having outer surfaces that are exposed to the weather and on which components must be sealingly attached to prevent ingress of moisture, vapors and air-borne contaminants through the joint between the component and the vessel.

While the invention has been particularly shown and described with reference to preferred examples thereof, it will be understood by those skilled in the art that various changes and modifications in form and details may be made thereto without departing from the spirit and scope of the invention as defined in the appended claims.

I claim:

1. A sealant template for use in sealing a boundary region between a component and a vessel to which the component is attached, the sealant template comprising: a support member; an inner template section removably adhesively adhered to the support member, the inner template section having a ring shape with an outer profile similar to but smaller than the peripheral profile of the component; and an outer template section removably adhesively adhered to the support member, the outer template section having a ring shape with an inner profile similar to but larger than the peripheral profile of the component.

2. A sealant template according to claim 1; wherein the inner and outer template sections each have at least one tab extending radially therefrom.

3. A sealant template according to claim 2; wherein each tab of the inner template section extends radially inwardly, and each tab of the outer template section extends radially outwardly.

4. A sealant template according to claim 2; wherein the inner and outer template sections each have two tabs.

5. A sealant template according to claim 2; wherein the inner and outer template sections each have weakened regions at which the section, after removal from the support member, can be separated into plural template section pieces.

6. A sealant template according to claim 5; wherein the weakened regions are located on the tabs.

7. A sealant template according to claim 6; wherein the weakened regions comprise perforated lines.

8. A sealant template according to claim 6; wherein the weakened regions comprise score lines.

9. A sealant template according to claim 1; wherein the inner and outer template sections each have weakened regions at which the section, after removal from the support member, can be separated into plural template section pieces.

10. A sealant template according to claim 9; wherein the weakened regions comprise perforated lines.

11. A sealant template according to claim 10; wherein the weakened regions comprise score lines.

12. A sealant template according to claim 1; wherein the inner and outer template sections have circular ring shapes.

13. A sealant template according to claim 1; wherein the inner and outer template sections have oblong ring shapes.

14. A sealant template according to claim 1; wherein the inner and outer template sections have rectangular ring shapes.

15. A sealant template according to claim 1; wherein the vessel is an aircraft or a water craft, and the component is an antenna, a connector, a window or a light.

16. A sealant template according to claim 1; wherein the ring-shaped inner template section is disposed on the support member inside the ring-shaped outer template section such that a ring-shaped gap exists between the outer profile of the inner template section and the inner profile of the outer template section.

17. A method of sealing a boundary region between a component and a vessel to which the component is attached, comprising the steps of:
providing ring-shaped inner and outer template sections removably adhesively adhered to a support member;
removing the inner template section from the support member and adhesively adhering it to a base of the component and removing the outer template section from the support member and adhesively adhering it to the vessel such that a ring-shaped gap exists between the inner and-outer template sections at a boundary region between the periphery of the component and the vessel;
filling the ring-shaped gap with a self-curing sealant; and
then removing the inner template section from the component and removing the outer template section from the vessel.

18. A method according to claim 17; further including the steps of separating the inner and outer template sections into plural section pieces and adhesively adhering the section pieces of the inner template section to the component and adhesively adhering the section pieces of the outer template section to the vessel.

19. A method according to claim 17; wherein the vessel is an aircraft or a water craft.

20. A method according to claim 19; wherein the component is an antenna, a connector, a window or a light.
